(19) United States
(12) Patent Application Publication
(10) Pub. No.: US 2008/0145292 A1
(43) Pub. Date: Jun. 19, 2008

(54) Barium Titanate, Production Process Thereof and Capacitor

(75) Inventors: Akihiko Shirakawa, Chiba-shi (JP); Hitoshi Yokouchi, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K.K., Tokyo (JP)

(21) Appl. No.: 11/661,120

(22) PCT Filed: Aug. 30, 2005
(86) PCT No.: PCT/JP05/16179

§ 371 Date: Dec. 7, 2007

Related U.S. Application Data
(60) Provisional application No. 60/608,121, filed on Sep. 9, 2004.

(30) Foreign Application Priority Data
Aug. 31, 2004 (JP) 2004-251249

(51) Int. Cl. C01D 1/02; C01G 23/04; C01F 17/00

(52) U.S. Cl. 423/263; 423/598; 423/594.4; 423/594.2

(57) ABSTRACT

The present invention provides a barium titanate having a small particle size, containing small amounts of unwanted impurities, and exhibiting excellent electric characteristics; and a process for producing the barium titanate.

The perovskite-type barium titanate comprising at least one element selected from the group consisting of Sn, Zr, Ca, Sr, Pb, and the like, in an amount of 5 mol % or less (inclusive of 0 mol %) based on BaTiO₃, wherein the molar ratio of A atom to B atom in the perovskite structure represented by ABX₃ (A atom is surrounded with 12× atoms, and B atom is surrounded with 6× atoms) is from 1.001 to 1.025, and the specific surface area x (m²/g) and the ratio y of the c-axis length to the a-axis length of the crystal lattice as calculated by the Rietveld method satisfy the following formula. y>1.0083−6.53×10⁻⁷×x3 (wherein y=c-axis length/a-axis length, and 6.6≦x≦20).

### TECHNICAL FIELD

The present invention relates to a barium titanate for use in dielectric materials, multilayer ceramic capacitors, piezoelectric materials and the like, and also relates to a production process thereof and a capacitor. More specifically, the present invention relates to a fine barium titanate with high tetragonality and a production process thereof.

Priority is claimed on Japanese Patent Application No. 2004-251249, filed Aug. 31, 2004, the content of which is incorporated herein by reference. This application is an application filed under 35 U.S.C. 111(a) claiming pursuant to 35 U.S.C. 119(e) of the filing date of Provisional Application 60/608,121 on Sep. 9, 2004, pursuant to 35 U.S.C. 111(b).

### BACKGROUND ART

The barium titanate is being widely used as a functional material, for example, in dielectric materials, multilayer ceramic capacitors and piezoelectric materials. With the progress of miniaturization and lightweighting of electronic parts, development of a process for obtaining a barium titanate having a smaller particle diameter and exhibiting excellent electric properties such as high dielectric constant is demanded.

A barium titanate having high tetragonality is known to have high dielectric constant but its particle diameter cannot be made to be sufficiently small, whereas a barium titanate having a small particle diameter cannot be elevated in the tetragonality and in turn a sufficiently high dielectric constant cannot be obtained.

Examples of the process for producing a titanium-containing composite oxide particle such as barium titanate include a solid-phase process of mixing powders of an oxide and a carbonate used as raw materials in a ball mill or the like and reacting the mixture at a high temperature of about 800° C. or more to produce a composite oxide particle; an oxalate process of preparing an oxalic acid composite salt and thermally decomposing the composite salt to obtain a titanium-containing composite oxide particle; an alkoxide process of using a metal alkoxide as a raw material and hydrolyzing it to obtain a precursor; a hydrothermal synthesis process of reacting raw materials in an aqueous solvent at high temperature and high pressure to obtain a precursor; a process of reacting a hydrolysate of a titanium compound with a water-soluble barium salt in a strong alkali aqueous solution (Patent Document 1); and a process of reacting a titanium oxide sol with a barium compound in an alkali aqueous solution (Patent Document 2).

Patent Document 1: Japanese Patent No. 1841875

Patent Document 2: International Patent Publication WO00/35811, pamphlet

### DISCLOSURE OF INVENTION

The solid-phase process has a problem that despite low production cost, the produced titanium-containing composite oxide particle has a large particle diameter and is not suitable for use as a functional material in dielectric materials, piezoelectric materials and the like. When the particle is ground, the particle diameter can be made small, but strain may occur due to the effect of grinding and a barium titanate having high tetragonality and high dielectric constant cannot be produced.

The oxalate process is disadvantageous in that although a smaller particle than that produced by the solid-phase process is obtained, carbonic acid derived from the oxalic acid remains and a barium titanate exhibiting excellent electric properties cannot be obtained.

The alkoxide process and the hydrothermal synthesis process have a problem that although a barium titanate having a fine particle diameter is obtained, a large amount of a hydroxyl group attributable to water taken into the inside remains and therefore, a barium titanate with excellent electric properties cannot be obtained. Also, in either of these methods, exclusive equipment is necessary and the cost rises, because a carbonic acid remains in the alkoxide process or the production is performed under high-temperature high-pressure conditions in the hydrothermal synthesis process.

Furthermore, the alkali used in the methods described in Patent Documents 1 and 2 is potassium hydroxide or sodium hydroxide and therefore, a step of removing such an alkali must be provided after the reaction, but the alkali removal step readily incurs dissolution of barium and entering of a hydroxyl group, and a barium titanate having high tetragonality can be hardly obtained.

An object of the present invention is to provide a barium titanate having a small particle diameter, being reduced in unnecessary impurities and exhibiting excellent electric properties, which can form a thin-film dielectric ceramic necessary for a small-sized capacitor capable of realizing miniaturization of electronic devices, and a production process thereof.

In order to attain the above-described object, the present invention employs the following constitutions.

As a result of intensive investigations to solve those problems, the present inventors have found that when a titanium oxide sol and a barium compound are reacted in an alkaline solution allowing for the presence of an alkali component under excess barium conditions and when the alkali component is removed in the form of a gas after the completion of reaction and the reaction product is fired, a barium titanate having a specific surface area as large as unobtainable in conventional production processes and at the same time, having high tetragonality can be obtained. The present invention has been accomplished based on this finding.

The present invention provides the following means.

[1] A perovskite-type barium titanate comprising at least one element selected from the group consisting of Sn, Zr, Ca, Sr, Pb, La, Ce, Mg, Bi, Ni, Al, Si, Zn, B, Nb, W, Mn, Fe, Cu, Ho, Y and Dy, in an amount of 5 mol % or less (inclusive of 0 mol %) based on BaTiO₃, wherein the molar ratio of A atom to B atom in the perovskite structure represented by ABX₃ (A atom is surrounded with 12× atoms, and B atom is surrounded with 6× atoms) is from 1.001 to 1.025, and the specific surface area x (m²/g) and the ratio y of the c-axis length to the a-axis length of the crystal lattice as calculated by the Rietveld method satisfy the following formula (1):

y>1.0083−6.53×10⁻⁷×x³ (1)

(wherein y=c-axis length/a-axis length, and 6.6<x≦20).

[2] The barium titanate as described in 1 above, wherein the specific surface area x (m²/g) and the ratio y of the c-axis length to the a-axis length of the crystal lattice as calculated by the Rietveld method satisfy the following formula:

y>1.0083−6.53×10⁻⁷×x³ (1)

(wherein y=c-axis length/a-axis length, and 7<x≦20).

[3] The barium titanate as described in 1 or 2 above, which is in the form of powder.

[4] A process for producing a barium titanate as recited in any one of 1 to 3, comprising:

a step of reacting a titanium oxide sol and a barium compound in an alkaline solution having a carboxylic acid group concentration of 500 ppm by mass or less in terms of CO₂ and allowing for the presence of a basic compound, to synthesize a barium titanate;

a step of removing the basic compound in the form of a gas after the completion of reaction; and a step of firing the barium titanate.

[5] The process for producing a barium titanate as described in 4 above, wherein the titanium oxide sol is produced by hydrolyzing a titanium compound under acidic conditions.

[6] The process for producing a barium titanate as described in 4 or 5 above, wherein the titanium oxide sol contains a brookite crystal.

[7] The process for producing a barium titanate as described in any one of 4 to 6 above, wherein the basic compound is a substance which becomes a gas by any one or more means of evaporation, sublimation and thermal decomposition at a firing temperature or less under atmospheric pressure or reduced pressure.

[8] The process for producing a barium titanate as described in 7 above, wherein the basic compound is an organic base compound.

[9] The process for producing a barium titanate as described in any one of 4 to 8 above, wherein the alkaline solution has a pH of 11 or more.

[10] The process for producing a barium titanate as described in any one of 4 to 9 above, wherein the step of removing the basic compound in the form of a gas is performed at a temperature ranging from room temperature to a firing temperature under atmospheric pressure or reduced pressure.

[11] The process for producing a barium titanate as described in any one of 4 to 9 above, wherein the step of removing the basic compound in the form of a gas is included in the firing step.

[12] The process for producing a barium titanate as described in any one of 4 to 11 above, wherein the firing step is performed at 300 to 1,200° C.

[13] The process for producing a barium titanate as described in any one of 4 to 12 above, wherein in the step of reacting a titanium oxide sol and a barium compound, a compound containing at least one element selected from the group consisting of Sn, Zr, Ca, Sr, Pb, La, Ce, Mg, Bi, Ni, Al, Si, Zn, B, Nb, W, Mn, Fe, Cu, Ho, Y and Dy is added.

[14] A barium titanate produced by the process described in any one of 4 to 13 above.

[15] A dielectric material comprising the barium titanate described in 1, 2, 3 or 14 above.

[16] A paste comprising the barium titanate described in 1, 2, 3 or 14 above.

[17] A slurry comprising the barium titanate described in 1, 2, 3 or 14 above.

[18] A thin-film shaped product comprising the barium titanate described in 1, 2, 3 or 14 above.

[19] A dielectric ceramic produced by using the barium titanate described in 1, 2, 3 or 14 above.

[20] A pyroelectric ceramic produced by using the barium titanate described in 1, 2, 3 or 14 above.

[21] A piezoelectric ceramic produced by using the barium titanate described in 1, 2, 3 or 14 above.

[22] A capacitor comprising the dielectric ceramic described in 19 above.

[23] An electronic device comprising at least one member selected from the group consisting of the thin-film shaped product, the ceramic and the capacitor described in any one of 18 to 22 above.

[24] A sensor comprising one species or two or more species of the thin-film shaped product or ceramic described in any one of 18 to 21 above.

[25] A dielectric film comprising the barium titanate described in 1, 2, 3 or 14 above.

[26] A capacitor produced by using the dielectric film described in 25 above.

### BRIEF DESCRIPTION OF THE DRAWINGS

FIG. 1 is a cross-sectional schematic view of a multilayer ceramic capacitor as a preferred embodiment of the present invention.

FIG. 2 is an exploded view showing the internal structure of a cellular phone equipped with the multilayer ceramic capacitor of FIG. 1.

The reference numerals shown in Fig.s are defined as follows: 1, Multilayer ceramic capacitor (capacitor); 2, Dielectric layer.

### BEST MODE FOR CARRYING OUT THE INVENTION

The present invention is described in detail below.

The barium titanate as a preferred embodiment of the present invention means BaTiO₃ which is a perovskite-type compound represented by the formula: ABX₃ (A atom is surrounded with 12× atoms and B atom is surrounded with 6× atoms), where A is occupied by Ba (barium), B is occupied by Ti (titanium) and X is occupied by O (oxygen). Also, in the barium titanate as a preferred embodiment of the present invention, the specific surface area x (m²/g) and the ratio y of the c-axis length to the a-axis length of the crystal lattice as calculated by the Rietveld method satisfy the following formula. Incidentally, the specific surface area x is preferably measured by the BET method.

Assuming that the c-axis length and the a-axis length of the tetragonal crystal are c and a, respectively, as the ratio c/a, that is, y in the following formula (1) is larger, the tetragonality and in turn the dielectric constant become larger.

y>1.0083−6.53×10⁻⁷×x³ (1)

(wherein y=c-axis length/a-axis length, and 6.6<x≦20).

In general, for the miniaturization of electronic device, as the BET specific surface area is larger, the barium titanate is more effective. The barium titanate in a preferred embodiment of the present invention has a specific surface area of 6.6 to 20 m²/g, preferably from 7 to 20 m²/g, more preferably from 9.7 to 20 m²/g. When the specific surface area exceeds 6.6 m²/g and at the same time, 20 m²/g or less, assuming that the c/a ratio is y and the specific surface area is x, a barium titanate satisfying formula (1) is effective. The method for measuring the specific surface area is not particularly limited and any known method can be employed, but a so-called BET specific surface area as calculated by the BET formula using a nitrogen adsorption method is preferably employed.

Furthermore, in formula ABX₃, when the molar ratio of A atom (Ba) to B atom (Ti) is from 1.001 to 1.025, this is effective for realizing a small particle diameter and a high dielectric constant. The molar ratio is more preferably from 1.001 to 1.02, still more preferably from 1.01 to 1.015.

The barium titanate as a preferred embodiment of the present invention may contain at least one element selected from the group consisting of Sn, Zr, Ca, Sr, Pb, La, Ce, Mg, Bi, Ni, Al, Si, Zn, B, Nb, W, Mn, Fe, Cu, Ho, Y and Dy, in an amount of 5 mol % or less based on BaTiO₃.

Such a barium titanate has a small particle diameter and excellent electric properties with high dielectric constant. When a dielectric material such as dielectric ceramic obtained from this barium titanate is used, a small-sized electric part such as multilayer ceramic capacitor is obtained. Furthermore, when such an electronic part is used for an electronic device, miniaturization and lightweighting of the electronic device can be realized.

The production process for the barium titanate as a preferred embodiment of the present invention is described below. This production process comprises a step of reacting a titanium oxide sol and a barium compound in an alkaline solution having a carboxylic acid group concentration of 500 ppm by mass or less, preferably 50 ppm by mass or less, in terms of CO₂ and allowing for the presence of a basic compound, a step of removing the basic compound in the form of a gas after the completion of reaction, and a step of firing the barium titanate.

The titanium oxide sol for use in this production process is not particularly limited, but a sol of titanium oxide containing a brookite crystal is preferred. As long as a brookite crystal is contained, the titanium oxide sol may contain a brookite titanium oxide alone or may contain a rutile-type titanium oxide and an anatase-type titanium oxide. In the case of containing a rutile-type titanium oxide and an anatase-type titanium oxide, the ratio of the brookite crystal in the titanium oxide is not particularly limited but is generally from 1 to 100 mass %, preferably from 10 to 100 mass %, more preferably from 50 to 100 mass %. In order to obtain excellent dispersibility of titanium oxide particles in a solvent, crystalline structure is easier in the formation of simple particles than amorphous structure and is preferred. Particularly, the brookite titanium oxide exhibits excellent dispersibility. The reason therefor is not clearly known but this is considered to have relationship with the fact the zeta potential of brookite titanium oxide is higher than that of rutile-type or anatase-type titanium oxide.

Examples of the process for producing a particulate titanium oxide containing a brookite crystal include a production process in which a particulate anatase-type titanium oxide is heat-treated to obtain a particulate titanium oxide containing a brookite crystal; and a liquid-phase production process in which a solution of a titanium compound such as titanium tetrachloride, titanium trichloride, titanium alkoxide or titanium sulfate is neutralized or hydrolyzed to obtain a titanium oxide sol having dispersed therein titanium oxide particles.

As for the process of producing a particulate titanium-containing composite oxide (barium titanate) starting from a particulate titanium oxide containing a brookite crystal, a process of hydrolyzing a titanium salt in an acidic solution to obtain a particulate titanium oxide in the form of a titanium oxide sol is preferred, because small particle diameter and excellent dispersibility are ensured. Specifically, a process in which titanium tetrachloride is added to hot water of 75 to 100° C. and the titanium tetrachloride is hydrolyzed at a temperature from 75° C. to the boiling point of the solution while controlling the chloride ion concentration, to obtain a brookite crystal-containing particulate titanium oxide in the form of a titanium oxide sol (JP-A-11-43327); and a process in which titanium tetrachloride is added to hot water of 75 to 100° C. and the titanium tetrachloride is hydrolyzed at a temperature from 75° C. to the boiling point of the solution in the presence of either one or both of nitrate ion and phosphate ion while controlling the total concentration of chloride ion, nitrate ion and phosphate ion, to obtain a brookite crystal-containing particulate titanium oxide in the form of a titanium oxide sol (International Patent Publication WO99/58451) are preferred.

The thus-obtained brookite crystal-containing particulate titanium oxide usually has a primary particle diameter of 5 to 50 nm. If the primary particle diameter exceeds 50 nm, the titanium-containing composite oxide particle (barium titanate) produced starting from this particulate titanium oxide comes to have a large particle diameter and is disadvantageously unsuited as a functional material used, for example, in dielectric materials and piezoelectric materials. If the primary particle size is less than 5 nm, the production of particulate titanium oxide encounters difficulty in handling and this may be industrially disadvantageous.

In the production process of a barium titanate as a preferred embodiment of the present invention, when a titanium oxide sol obtained by hydrolyzing a titanium salt in an acidic solution is used, the particulate titanium oxide in the obtained sol is not limited in its crystal form and not limited to a brookite crystal.

When a titanium salt such as titanium tetrachloride or titanium sulfate is hydrolyzed in an acidic solution, the reaction rate is reduced as compared with the case of performing the hydrolysis in a neutral or alkaline solution and therefore, a titanium oxide sol with simple particle diameter and excellent dispersibility is obtained. Furthermore, anion such as chloride ion and sulfate ion can be hardly taken into the inside of the produced titanium oxide particle and therefore, when a titanium-containing particulate composite oxide is produced, the intermingling of anion into the particle can be decreased.

On the other hand, when the hydrolysis is performed in a neutral or alkaline solution, the reaction rate increases and many nucleations occur in the initial stage, as a result, a titanium oxide sol having bad dispersibility despite a small particle diameter is produced, causing vine-like aggregation of particles. If a titanium-containing particulate composite oxide (barium titanate) is produced by using such a titanium oxide sol as the raw material, the obtained particles may suffer from bad dispersibility despite a small particle diameter. In addition, anion readily intermingles into the inside of the titanium oxide particle and the removal of such anion in the subsequent step is difficult.

The process for hydrolyzing a titanium salt in an acidic solution to obtain a titanium oxide sol is not particularly limited as long as the solution can be kept acidic, but a process of using titanium tetrachloride as the raw material, performing the hydrolysis in a reactor equipped with a reflux condenser, and keeping the solution acidic by suppressing the escape of chlorine generated there (JP-A-11-43327) is preferred.

The concentration of the raw material titanium salt in the acidic solution is preferably from 0.01 to 5 mol/L. If the concentration exceeds 5 mol/L, the reaction rate of hydrolysis increases and a titanium oxide sol with a large particle size and bad dispersibility is obtained, whereas if it is less than 0.01 mol/L, the concentration of the titanium oxide obtained decreases, giving rise to bad productivity.

The barium compound for use in the production process is preferably water-soluble and usually, this compound is preferably a hydroxide, a nitrate, an acetate, a chloride or the like. One barium compound may be used alone, or two or more compounds may be mixed at an arbitrary ratio and used. Specific examples of the barium compound which can be used include barium hydroxide, barium chloride, barium nitrate and barium acetate.

The barium titanate as a preferred embodiment of the present invention can be produced by a process of reacting a brookite crystal-containing particulate titanium oxide and a barium compound, or a process of hydrolyzing a titanium salt in an acidic solution and reacting the obtained titanium oxide sol with a barium compound. In particular, a process of reacting a titanium oxide sol and a barium compound in an alkaline solution is more preferred.

As for the conditions of the reaction between the titanium oxide sol and the barium compound, the reaction is preferably performed in an alkaline solution in which a basic compound is present. The pH of the solution is preferably 11 or more, more preferably 13 or more, still more preferably 14 or more. When the pH is adjusted to 14 or more, a barium titanate with a smaller particle diameter can be produced. Specifically, the reaction solution is preferably kept alkaline at a pH of 11 or more by adding thereto an organic base compound.

The basic compound added here is not particularly limited but a substance of becoming a gas through evaporation, sublimation and/or thermal decomposition at a firing temperature or less under atmospheric or reduced pressure, which is described later, is preferred. For example, TMAH (tetramethylammonium hydroxide) and choline may be preferably used. If an alkali metal hydroxide such as lithium hydroxide, sodium hydroxide or potassium hydroxide is added, an alkali metal may remain in the obtained titanium-containing particulate composite oxide and when a functional material such as dielectric material and piezoelectric material is produced through shaping and sintering, the functional material may suffer from poor properties. Therefore, it is preferred to add the above-described basic compound such as tetramethylammonium hydroxide.

Furthermore, a barium titanate having a large c/a can be stably produced by controlling the concentration of a carbonic acid group (the carbonic acid species including CO₂, H₂CO₃, HCO₃⁻ and CO₃²⁻) in the reaction solution. The concentration of a carbonate group (in terms of CO₂; unless otherwise indicated, hereinafter the same) in the reaction solution is preferably 500 ppm by mass or less, more preferably from 1 to 200 ppm by mass, still more preferably from 1 to 100 ppm by mass. When the carbonic acid group concentration is within this range, a barium titanate having a large y value (c/a) is difficult to obtain.

The reaction solution is preferably prepared such that the concentration of particulate titanium oxide or titanium oxide sol is from 0.1 to 5 mol/L and the concentration of barium-containing metal salt is from 0.1 to 5 mol/L in terms of metal oxide. Furthermore, a compound of at least one element selected from the group consisting of Sn, Zr, Ca, Sr, Pb, La, Ce, Mg, Bi, Ni, Al, Si, Zn, B, Nb, W, Mn, Fe, Cu, Ho, Y and Dy may be added to the barium titanate after the reaction so that such an element can be contained in an amount of 5 mol % or less based on BaTiO₃. The kind and amount added of this element may be adjusted such that, for example, when a capacitor is produced, the capacitor has desired properties such as temperature property.

The thus-prepared alkali solution is usually heated and kept at a temperature of 40° C. to the boiling point of the solution, preferably from 80° C. to the boiling point of the solution, while stirring under atmospheric pressure, whereby the reaction is allowed to proceed. The reaction time is usually 1 hour or more, preferably 4 hours or more.

The slurry after the completion of reaction is generally subjected to removal of impurity ion by a method using electrodialysis, ion exchange, water washing, washing with acid, permeable membrane or the like. However, barium contained in the barium titanate is also ionized and partially dissolved simultaneously with the impurity ion and therefore, control to a desired compositional ratio is difficult. Furthermore, crystal defects are generated and in turn the c/a ratio becomes small. Therefore, without using such a method, the step of removing impurities (e.g., basic compound) is preferably performed by the method described later.

The slurry after the completion of reaction is then fired, whereby a barium titanate as a preferred embodiment of the present invention can be produced. By the firing, crystallinity of barium titanate is enhanced and at the same time, remaining impurities such as anion (e.g., chloride ion, sulfate ion, phosphate ion) and basic compound (e.g., tetramethylammonium hydroxide) are removed in the form of a gas through evaporation, sublimation and/or thermal decomposition. The firing is usually performed at a temperature of 300 to 1,200° C. The firing atmosphere is not particularly limited and the firing is usually performed in air.

If desired, in view of handing or the like, the slurry may be subjected to solid-liquid separation before firing. The solid-liquid separation may be performed by a step such as precipitation, concentration, filtration, and/or drying. In the precipitation, concentration or filtration step, a coagulant or dispersant may be used so as to change the precipitation rate or filtration rate. The drying step is a step of evaporating or sublimating the liquid components, and a method such as drying under reduced pressure, hot-air drying or freeze-drying is used therefor.

The firing may also be performed after previously removing a basic compound and the like in the form of a gas at a temperature in the range from room temperature to firing temperature under atmospheric or reduced pressure.

The thus-produced barium titanate exhibits excellent electric properties, in which the specific surface area x (m²/g) and the ratio y of the c-axis length (unit: nm) to the a-axis length (unit: nm) of the crystal lattice as calculated by the Rietveld method satisfy formula (1). Furthermore, the thus-obtained barium titanate is used after shaping it into a dielectric ceramic, a pyroelectric ceramic, a piezoelectric ceramic or a thin-film shaped product, and such a ceramic or thin-film shaped product is used for capacitor materials, sensors and the like.

Also, the barium titanate powder may be used after the barium titanate powder alone or mixed with other materials is formed into a slurry or paste by using one or more solvent comprising water, a known inorganic binder or a known organic binder.

The electric properties of barium titanate can be evaluated by firing a disc shaped after adding various additives such as sintering aid to the powder or a thin-film product shaped after adding various additives to the slurry or paste containing the powder, under appropriate conditions and then measuring the fired body with use of an impedance analyzer or the like.

When a filler containing the barium titanate is dispersed in at least one member selected from a thermosetting resin and a thermoplastic resin, a film with high dielectric constant can be obtained. In the case of incorporating a filler other than barium titanate, one or more member selected from the group consisting of alumina, titania, zirconia and tantalum oxide may be selected and used.

The thermosetting resin and thermoplastic resin are not particularly limited and a generally employed resin may be used, but suitable examples of the thermosetting resin include epoxy resin, polyimide resin, polyamide resin and bistriazine resin, and suitable examples of the thermoplastic resin include polyolefin resin, styrene-based resin and polyamide.

In order to uniformly disperse the barium titanate-containing filler in at least one member selected from a thermosetting resin and a thermoplastic resin, the filler is preferably dispersed in advance in a solvent or in a mixture of the above-described resin composition and a solvent to obtain a slurry. The method for obtaining a slurry is not particularly limited but preferably contains a wet grinding step. Also, the solvent is not particularly limited and any solvent may be used as long as it is a generally employed solvent, but, for example, methyl ethyl ketone, toluene, ethyl acetate, methanol, ethanol, N,N-dimethylformamide, N,N-dimethylacetamide, N-methylpyrrolidone and methyl cellosolve may be used individually or in combination of two or more thereof.

In order to obtain a slurry by dispersing the filler in a solvent or in a mixture of the above-described resin composition and a solvent, the filler may also be treated with a coupling agent. The coupling agent is not particularly limited and examples thereof include a silane coupling agent, a titanate-based coupling agent and an aluminate-based coupling agent. The hydroxyl group of the coupling agent reacts with an active hydrogen on the surface of the filler containing barium titanate of the present invention to cover the surface and therefore, dispersibility in a solvent becomes good. The hydrophobic group of the coupling agent may elevate the compatibility with the resin depending on the hydrophobic group selected. For example, in the case of using an epoxy resin as the resin, the coupling agent is suitably a silane coupling agent in which any one of monoamino, diamino, cationic styryl, epoxy, mercapto, anilino, ureido and the like is present in one functional group, or a titanate-based coupling agent in which any one of phosphite, amino, diamino, epoxy, mercapto and the like is present in one functional group. In the case of using a polyimide resin as the resin, the coupling agent is preferably a silane coupling agent in which any one of monoamino, diamino, anilino and the like is present in one functional group, or a titanate-based coupling agent in which any one of monoamino and diamino is present in one functional group. One of these coupling agents may be used alone, or two or more thereof may be mixed and used.

The amount blended of the coupling agent is not particularly limited and it may sufficient if a part or the entire of the barium titanate powder is covered, but if the amount blended is too large, the coupling agent may remain unreacted and give an adverse effect, whereas if too small, the coupling effect may decrease. Therefore, the amount blended is preferably selected to allow for uniform dispersion of the filler according to the particle diameter and specific surface area of the barium titanate powder-containing filler and the kind of the coupling agent. The amount of the coupling agent blended is preferably on the order of 0.05 to 20 wt % based on the barium titanate powder-containing filler.

In order to complete the reaction between the hydrophilic group of the coupling agent and the active hydrogen on the surface of the barium titanate powder-containing filler, a step of heat-treating the slurry formed is preferably provided. The heating temperature and time are not particularly limited, but the heat-treatment is preferably performed at 100 to 150° C. for 1 to 3 hours. When the boiling point of the solvent is 100° C. or less, the heating temperature is set to the boiling point of the solvent or less and the heating time may be prolonged according to the heating temperature set.

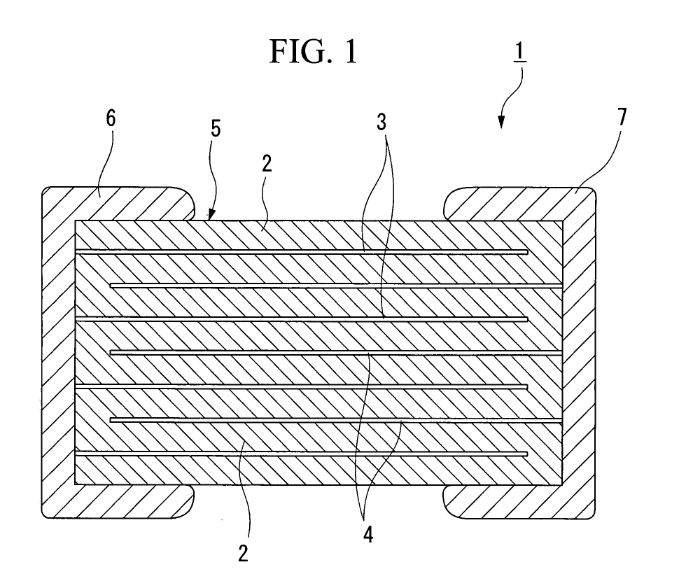

FIG. 1 is a cross-sectional schematic view of a multilayer ceramic capacitor as one example of the capacitor. As shown in FIG. 1, the multilayer ceramic capacitor 1 comprises a stacked body 5 in which a dielectric layer 2 and internal electrodes 3 and 4 are sequentially stacked, and an external electrodes 6 and 7 fixed on the side surfaces of the stacked body 5. The internal electrodes 3 and 4 each is exposed at one end to the side surface of the stacked body 5 and each one end is connected to the external electrode 6 or 7.

The dielectric layer 2 is formed by solidifying and shaping a barium calcium titanate powder with use of a binder or the like, and the internal electrodes 3 and 4 each comprises, for example, Ni, Pd or Ag. The external electrodes 6 and 7 each comprises, for example, a sintered body of Ag, Cu or Ni, which is subjected to Ni plating.

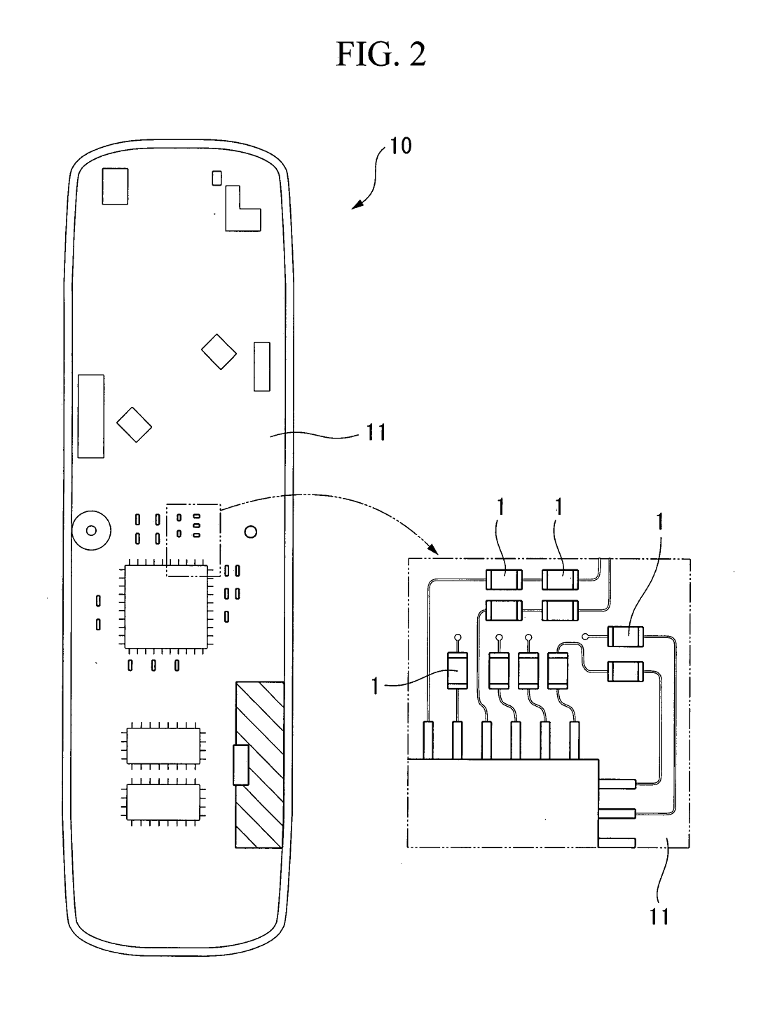

The capacitor 1 shown in FIG. 1 is used, for example, by packaging it, as shown in FIG. 2, on a circuit board 11 of a cellular phone 10.

One example of the production method of the multilayer ceramic capacitor is described below.

A barium titanate powder, a binder, a dispersant and water are mixed to produce a slurry. The slurry is preferably vacuum-deaerated in advance.

This slurry is thinly coated on a substrate by a doctor blade method or the like and then heated to evaporate water, whereby a dielectric layer mainly comprising a barium titanate powder is formed.

On this dielectric layer, a metal paste such as Ni, Pd and Ag is coated, another dielectric layer is stacked thereof, and a metal paste working out to the internal electrode is further coated. This step is repeatedly performed, whereby a stacked body in which a dielectric layer and an internal electrode are sequentially stacked is obtained. The stacked body is preferably pressed to tightly contact the dielectric layer and the internal electrode.

Subsequently, the stacked body is cut into a capacitor size and fired at 1,000 to 1,350° C. After the firing, an external electrode paste is coated on the side surface of the stacked body and fired at 600 to 850° C. Finally, the surface of the external electrode is subjected to Ni plating.

In this way, a multilayer ceramic capacitor 1 shown in FIG. 1 is obtained.

In the multilayer ceramic capacitor 1 obtained above, a barium titanate with high dielectric constant as a preferred embodiment of the present invention is used for the dielectric material, so that the electrostatic capacitance of the capacitor can be increased. Furthermore, in the capacitor, a barium titanate having a small particle diameter as a preferred embodiment of the present invention is used for the electric material, so that the thickness of the dielectric layer can be made small and in turn, the capacitor itself can be miniaturized. Also, by virtue of the decreased thickness of the dielectric layer, the electrostatic capacitance of the capacitor can be more increased.

This small-sized multilayer ceramic capacitor can be suitably used as a part of electronic devices, particularly portable devices including cellular phone.

### EXAMPLES

The present invention is described in greater detail below by referring to Examples and Comparative Examples, but the present invention is not limited to these Examples.

### Example 1

An aqueous solution containing titanium tetrachloride (produced by Sumitomo Sitix, purity: 99.9%) at a concentration of 0.25 mol/L was charged into a reactor equipped with a reflux condenser, and the solution was heated to a temperature near the boiling point while preventing escape of chloride ion and keeping the solution acidic. The solution was kept at that temperature for 60 minutes, thereby hydrolyzing titanium tetrachloride, to obtain a titanium oxide sol.

The obtained titanium oxide sol was dried at 110° C. and the crystal type was examined by an X-ray diffraction apparatus (RAD-B Rotor Flex, manufactured by Rigaku Corporation), as a result, this titanium oxide was found to be a brookite titanium oxide.

Thereafter, 126 g of barium hydroxide octahydrate (produced by Barium Chemicals Co., Ltd.) and 456 g of an aqueous 20 mass % tetramethylammonium hydroxide solution (produced by Sachem Showa) were added and after adjusting the pH to 14, heated to 95° C. in a reactor equipped with a reflux condenser. Thereafter, 211 g of a sol having a titanium oxide concentration of 15 mass % obtained by precipitating and concentrating the titanium oxide sol prepared above was added dropwise to the reactor at a rate of 7 g/min. The liquid temperature was elevated to 110° C. and while continuing stirring, the solution was kept for 4 hours, thereby allowing the reaction to proceed. The resulting slurry was left cooling to 50° C. and then filtered, and the obtained filter cake was dried at 300° C. for 5 hours to obtain a fine particulate barium titanate powder.

The ratio of the actual yield to the theoretical yield calculated from the amounts of the titanium oxide and barium hydroxide used for the reaction was 99.8%.

Also, the molar ratio of A atom to B atom of the obtained barium titanate powder was examined by a glass bead method using a fluorescent X-ray analyzer (RIX3100, manufactured by Rigaku Corporation) and found to be 1.010.

Thereafter, in order to crystallize the barium titanate powder, the powder was kept at 900° C. for 2 hours in an air atmosphere. At this time, the temperature rising rate was 20° C./min.

After this heat treatment, the X-ray diffraction pattern of the barium titanate powder was examined by the X-ray diffraction analyzer described above, as a result, the obtained powder was found to be perovskite-type BaTiO₃. Based on the X-ray diffraction, the c/a ratio was determined by the Rietveld analysis and found to be 1.0093. The specific surface area x determined by the BET method was 9.5 m²/g. The y value obtained by assigning the specific surface area x value (9.5 m²/g) to formula (1) was 1.0077, and this value was found to be smaller than the c/a value (1.0093) determined by the Rietveld analysis. That is, the barium titanate of this Example satisfied formula (1).

Subsequently, the amount of the carbonic acid group contained in the barium titanate powder was determined by infrared spectroscopy. Assuming that all carbonic acid groups are barium carbonate, the amount was corresponding to 1 mass %. At the same time, although it is known that when a hydroxyl group is present in the crystal lattice, a sharp absorption peak appears in the vicinity of 3,500 cm⁻¹, such an absorption peak did not appear in the sample of this Example.

Thereafter, the sample of this Example was weighed and MgO, Ho₂O₃ and BaSiO₃ were weighed to occupy 0.5 mol %, 0.75 mol % and 2.0 mol %, respectively, based on the sample of this Example. After adding pure water, the weighed raw materials were mixed in a wet ball mill, and the mixture was dried. An organic binder (polyvinyl alcohol) was added to the mixture and a granulated powder was produced. Then, 0.3 g of the granulated powder was weighed and shaped in a mold with an inner diameter of 11 mm by applying a pressure of 1 t/cm² (98 MPa) to obtain a compact. This compact was heated in an electric furnace at 450° C. for 1 hour to remove the binder component and then further fired at 1,180° C. for 2 hours. The diameter, thickness and weight of the sample after firing were measured. Subsequently, a silver paste was coated on both disc surfaces and baked at 800° C. to form electrodes, thereby producing a sample for the measurement of electric properties.

The obtained sample was measured on the temperature properties of relative dielectric constant and electrostatic capacitance. The results obtained are shown in Table 1.

### Example 2

A perovskite-type fine particulate BaTiO₃ powder was obtained in the same manner as in Example 1.

This powder was examined in the same manner as in Example 1, as a result, the specific surface area was 7.7 m²/g and the c/a ratio determined by the Rietveld analysis was 1.0104. This c/a ratio was found to be larger than the c/a ratio (1.0080) calculated by assigning the specific surface area (7.7 m²/g) to formula (1). Also, the electric properties were measured in the same manner as in Example 1. The results obtained are shown in Table 1.

### Example 3

A perovskite-type fine particulate BaTiO₃ powder was obtained in the same manner as in Example 1. The obtained powder was kept at 800° C. for 2 hours and thereby crystallized.

This powder was examined in the same manner as in Example 1, as a result, the specific surface area was 12.5 m²/g and the c/a ratio determined by the Rietveld analysis was 1.0074. This c/a ratio was found to be larger than the c/a ratio (1.0070) calculated by assigning the specific surface area (12.5 m²/g) to formula (1). Also, the electric properties were measured in the same manner as in Example 1. The results obtained are shown in Table 1.

### Example 4

A perovskite-type fine particulate BaTiO₃ powder was obtained in the same manner as in Example 1. The obtained powder was kept at 650° C. for 2 hours and thereby crystallized.

This powder was examined in the same manner as in Example 1, as a result, the specific surface area was 19.5 m²/g and the c/a ratio determined by the Rietveld analysis was 1.0040. This c/a ratio was found to be larger than the c/a ratio (1.0035) calculated by assigning the specific surface area (19.5 m²/g) to formula (1). Also, the electric properties were measured in the same manner as in Example 1. The results obtained are shown in Table 1.

### Example 5

A perovskite-type fine particulate BaTiO₃ powder was obtained in the same manner as in Example 1 except for changing the amount of titanium oxide sol added dropwise to 213 g. When examined in the same manner as in Example 1, the molar ratio of A atom to B atom was 1.001.

The obtained powder was kept at 880° C. for 2 hours and thereby crystallized. This powder was examined in the same manner as in Example 1, as a result, the specific surface area was 7.0 m²/g and the c/a ratio determined by the Rietveld analysis was 1.0105. This c/a ratio was found to be larger than the c/a ratio (1.0081) calculated by assigning the specific surface area (7.0 m²/g) to formula (1). Also, the electric properties were measured in the same manner as in Example 1. The results obtained are shown in Table 1.

### Example 6

A perovskite-type fine particulate BaTiO₃ powder was obtained in the same manner as in Example 5. The obtained powder was kept at 800° C. for 2 hours and thereby crystallized.

This powder was examined in the same manner as in Example 1, as a result, the specific surface area was 9.5 m²/g and the c/a ratio determined by the Rietveld analysis was 1.0079. This c/a ratio was found to be larger than the c/a ratio (1.0077) calculated by assigning the specific surface area (9.5 m²/g) to formula (1). Also, the electric properties were measured in the same manner as in Example 1. The results obtained are shown in Table 1.

### Example 7

A perovskite-type fine particulate BaTiO₃ powder was obtained in the same manner as in Example 1 except for changing the amount of titanium oxide sol added dropwise to 212 g. When examined in the same manner as in Example 1, the molar ratio of A atom to B atom was 1.005.

The obtained powder was kept at 900° C. for 2 hours and thereby crystallized. This powder was examined in the same manner as in Example 1, as a result, the specific surface area was 7.7 m²/g and the c/a ratio determined by the Rietveld analysis was 1.0106. This c/a ratio was found to be larger than the c/a ratio (1.0080) calculated by assigning the specific surface area (7.7 m²/g) to formula (1). Also, the electric properties were measured in the same manner as in Example 1. The results obtained are shown in Table 1.

### Example 8

A perovskite-type fine particulate BaTiO₃ powder was obtained in the same manner as in Example 7. The obtained powder was kept at 800° C. for 2 hours and thereby crystallized.

This powder was examined in the same manner as in Example 1, as a result, the specific surface area was 10.2 m²/g and the c/a ratio determined by the Rietveld analysis was 1.0080. This c/a ratio was found to be larger than the c/a ratio (1.0076) calculated by assigning the specific surface area (10.2 m²/g) to formula (1). Also, the electric properties were measured in the same manner as in Example 1. The results obtained are shown in Table 1.

### Example 9

A perovskite-type fine particulate BaTiO₃ powder was obtained in the same manner as in Example 1 except for changing the amount of titanium oxide sol added dropwise to 210 g. When examined in the same manner as in Example 1, the molar ratio of A atom to B atom was 1.015.

The obtained powder was kept at 1,000° C. for 2 hours and thereby crystallized. This powder was examined in the same manner as in Example 1, as a result, the specific surface area was 6.7 m²/g and the c/a ratio determined by the Rietveld analysis was 1.0090. This c/a ratio was found to be larger than the c/a ratio (1.0081) calculated by assigning the specific surface area (6.7 m²/g) to formula (1). Also, the electric properties were measured in the same manner as in Example 1. The results obtained are shown in Table 1.

### Example 10

A perovskite-type fine particulate BaTiO₃ powder was obtained in the same manner as in Example 9. The obtained powder was kept at 900° C. for 2 hours and thereby crystallized.

This powder was examined in the same manner as in Example 1, as a result, the specific surface area was 11.5 m²/g and the c/a ratio determined by the Rietveld analysis was 1.0090. This c/a ratio was found to be larger than the c/a ratio (1.0073) calculated by assigning the specific surface area (11.5 m²/g) to formula (1). Also, the electric properties were measured in the same manner as in Example 1. The results obtained are shown in Table 1.

### Example 11

A perovskite-type fine particulate BaTiO₃ powder was obtained in the same manner as in Example 9. The obtained powder was kept at 800° C. for 2 hours and thereby crystallized.

This powder was examined in the same manner as in Example 1, as a result, the specific surface area was 13.3 m²/g and the c/a ratio determined by the Rietveld analysis was 1.0069. This c/a ratio was found to be larger than the c/a ratio (1.0068) calculated by assigning the specific surface area (13.3 m²/g) to formula (1). Also, the electric properties were measured in the same manner as in Example 1. The results obtained are shown in Table 1.

### Example 12

A perovskite-type fine particulate BaTiO₃ powder was obtained in the same manner as in Example 1 except for changing the amount of titanium oxide sol added dropwise to 208 g. When examined in the same manner as in Example 1, the molar ratio of A atom to B atom was 1.025.

The obtained powder was kept at 1,200° C. for 2 hours and thereby crystallized. This powder was examined in the same manner as in Example 1, as a result, the specific surface area was 7.4 m²/g and the c/a ratio determined by the Rietveld analysis was 1.0081. This c/a ratio was found to be larger than the c/a ratio (1.0080) calculated by assigning the specific surface area (7.4 m²/g) to formula (1). Also, the electric properties were measured in the same manner as in Example 1. The results obtained are shown in Table 1.

### Example 13

A perovskite-type fine particulate BaTiO₃ powder was obtained in the same manner as in Example 12. The obtained powder was kept at 1,000° C. for 2 hours and thereby crystallized.

This powder was examined in the same manner as in Example 1, as a result, the specific surface area was 9.9 m²/g and the c/a ratio determined by the Rietveld analysis was 1.0080. This c/a ratio was found to be larger than the c/a ratio (1.0077) calculated by assigning the specific surface area (9.9 m²/g) to formula (1). Also, the electric properties were measured in the same manner as in Example 1. The results obtained are shown in Table 1.

### Example 14

A perovskite-type fine particulate BaTiO₃ powder was obtained in the same manner as in Example 12. The obtained powder was kept at 900° C. for 2 hours and thereby crystallized.

This powder was examined in the same manner as in Example 1, as a result, the specific surface area was 17.0 m²/g and the c/a ratio determined by the Rietveld analysis was 1.0052. This c/a ratio was found to be larger than the c/a ratio (1.0051) calculated by assigning the specific surface area (17.0 m²/g) to formula (1). Also, the electric properties were measured in the same manner as in Example 1. The results obtained are shown in Table 1.

### Example 15

A barium titanate was synthesized by the same operation as in Example 1 except for decreasing the amount of TMAH added and adjusting the pH to 11. The ratio of the actual yield to the theoretical yield was 98%.

The sample kept at 900° C. for 2 hours and thereby crystallized was examined in the same manner as in Example 1, as a result, the specific surface area was 9.8 m²/g and the c/a ratio determined by the Rietveld analysis was 1.0088. This c/a ratio was found to be larger than the c/a ratio (1.0077) calculated by assigning the specific surface area (9.8 m²/g) to formula (1). Also, the electric properties were measured in the same manner as in Example 1. The results obtained are shown in Table 1.

### Example 16

A barium titanate was synthesized by the same operation as in Example 1 except for using choline in place of TMAH. The ratio of the actual yield to the theoretical yield was 99.9%.

The sample kept at 900° C. for 2 hours and thereby crystallized was examined in the same manner as in Example 1, as a result, the specific surface area was 8.9 m²/g and the c/a ratio determined by the Rietveld analysis was 1.0090. This c/a ratio was found to be larger than the c/a ratio (1.0078) calculated by assigning the specific surface area (8.9 m²/g) to formula (1). Also, the electric properties were measured in the same manner as in Example 1. The results obtained are shown in Table 1.

### Example 17

A barium titanate was synthesized by the same operation as in Example 1 except for using a commercially available anatase-type titanium oxide sol (ST-02, produced by Ishihara Sangyo Kaisha Ltd.) in place of the brookite titanium oxide sol synthesized in Example 1. The ratio of the actual yield to the theoretical yield was 99.8%.

The sample kept at 900° C. for 2 hours and thereby crystallized was examined in the same manner as in Example 1, as a result, the specific surface area was 8.1 m²/g and the c/a ratio determined by the Rietveld analysis was 1.0081. This c/a ratio was found to be larger than the c/a ratio (1.0080) calculated by assigning the specific surface area (8.1 m²/g) to formula (1). Also, the electric properties were measured in the same manner as in Example 1. The results obtained are shown in Table 1.

### Comparative Example 1

A perovskite-type fine particulate BaTiO₃ powder was obtained in the same manner as in Example 1 except for changing the amount of titanium oxide sol added dropwise to 214 g. When examined in the same manner as in Example 1, the molar ratio of A atom to B atom was 0.995.

The obtained powder was kept at 830° C. for 2 hours and thereby crystallized. This powder was examined in the same manner as in Example 1, as a result, the specific surface area was 7.1 m²/g and the c/a ratio determined by the Rietveld analysis was 1.0080. This c/a ratio was found to be smaller than the c/a ratio (1.0081) calculated by assigning the specific surface area (7.1 m²/g) to formula (1). Also, the electric properties were measured in the same manner as in Example 1. The results obtained are shown in Table 1.

### Comparative Example 2

An aqueous oxalic acid solution was heated to 80° C. with stirring and thereto, an aqueous mixture solution of BaCl₂ and TiCl₄ was added dropwise to obtain a barium titanyl oxalate. This sample was thermally decomposed at 880° C. to obtain BaTiO₃.

The obtained BaTiO₃ was examined in the same manner as in Example 1, as a result, the specific surface area was 7.2 m²/g and the c/a ratio determined by the Rietveld analysis was 1.0064. This c/a ratio was found to be smaller than the c/a ratio (1.0081) calculated by assigning the specific surface area (7.2 m²/g) to formula (1).

Also, the amount of carbonic acid group contained in this sample was determined by an infrared spectrometer, as a result, it was found that a carbonic acid group in an amount of 8 mass % in terms of barium carbonate was present. It is presumed that since a large amount of carbonic acid group working as an impurity is produced in this way, the tetragonality (c/a) is not elevated, that is, the dielectric properties as a dielectric material are poor. The electric properties were measured in the same manner as in Example 1. The results obtained are shown in Table 1.

### Comparative Example 3

In a 3 L-volume autoclave, 667 g of the brookite titanium oxide sol synthesized in Example 1, 592 g of barium hydroxide octahydrate (Ba/Ti ratio: 1.5) and 1 liter of ion exchanged water were charged and kept at 150° C. for 1 hour to perform a hydrothermal treatment under saturation vapor pressure. The obtained sample was kept at 800° C. for 2 hours and thereby crystallized.

This sample was examined in the same manner as in Example 1, as a result, the specific surface area was 6.9 m²/g and the c/a ratio determined by the Rietveld analysis was 1.0033. This c/a ratio was found to be smaller than the c/a ratio (1.0081) calculated by assigning the specific surface area (6.9 m²/g) to formula (1).

Also, this sample was evaluated by an infrared spectrometer and found to have steep absorption in the vicinity of 3,500 cm⁻¹ attributable to a hydroxyl group in the crystal lattice. It is presumed that in the hydrothermal synthesis method, a hydroxyl group is carried over into the crystal lattice and therefore, the tetragonality (c/a) decreases. The electric properties were measured in the same manner as in Example 1. The results obtained are shown in Table 1.

### Comparative Example 4

A perovskite-type fine particulate BaTiO₃ powder was obtained in the same manner as in Example 1. The obtained powder was kept at 300° C. for 2 hours and thereby crystallized.

This powder was examined in the same manner as in Example 1, as a result, the specific surface area was 45 m²/g and the c/a ratio determined by the Rietveld analysis was 1.0030. Also, the electric properties were measured in the same manner as in Example 1. The results obtained are shown in Table 1.

### Comparative Example 5

A barium titanate was synthesized by the same operation as in Example 1 except for not adding TMAH. The pH of the reaction was 10.2. The ratio of the actual yield to the theoretical yield was 86%. It is understood that when the pH decreases, the yield decreases and this is not practical.

### Comparative Example 6

A barium titanate was obtained by the same operation as in Example 1 except for using KOH in place of TMAH. The ratio of the actual yield to the theoretical yield was 99.9%.

The obtained sample was filtered and washed with water to a K concentration of 100 ppm. Also, the sample was kept at 800° C. for 2 hours and thereby crystallized. This sample was examined in the same manner as in Example 1, as a result, the specific surface area was 9 m²/g and the c/a ratio determined by the Rietveld analysis was 1.0030. This c/a ratio was found to be smaller than the c/a ratio (1.0078) calculated by assigning the specific surface area (9 m²/g) to formula (1).

Furthermore, this sample was evaluated by an infrared spectrometer and found to have steep absorption in the vicinity of 3,500 cm⁻¹ attributable to a hydroxyl group in the crystal lattice. In addition, the Ba/Ti ratio was 0.007 smaller than that before washing and this suggests that Ba dissolves out simultaneously with K.

TABLE 1

| Name of | Density of | Relative Dielectric | Temperature |
|---|---|---|---|
| Sample | Sample (g/cm³) | Constant | Properties, X5R |
| Example 1 | 5.75 | 2240 | ◯ |
| Example 2 | 5.81 | 2400 | ◯ |
| Example 3 | 5.45 | 1960 | ◯ |
| Example 4 | 5.12 | 1740 | ◯ |
| Example 5 | 5.84 | 2460 | ◯ |
| Example 6 | 5.73 | 1990 | ◯ |
| Example 7 | 5.8 | 2460 | ◯ |
| Example 8 | 5.58 | 2000 | ◯ |
| Example 9 | 5.88 | 2150 | ◯ |
| Example 10 | 5.51 | 2220 | ◯ |
| Example 11 | 5.3 | 1880 | ◯ |
| Example 12 | 5.83 | 1990 | ◯ |
| Example 13 | 5.6 | 1960 | ◯ |
| Example 14 | 5.21 | 1800 | ◯ |
| Example 15 | 5.69 | 2160 | ◯ |
| Example 16 | 5.77 | 2130 | ◯ |
| Example 17 | 5.7 | 1990 | ◯ |
| Comparative | 5.84 | 1970 | X |
| Example 1 | | | |
| Comparative | 5.75 | 1840 | ◯ |
| Example 2 | | | |
| Comparative | 5.8 | 1600 | X |
| Example 3 | | | |
| Comparative | 4.84 | 860 | X |
| Example 4 | | | |
| Comparative | — | — | — |
| Example 5 | | | |
| Comparative | 5.74 | 1250 | X |
| Example 6 | | | |

### INDUSTRIAL APPLICABILITY

In a preferred embodiment of the present invention, the specific surface area x and the ratio y of the c-axis length to the a-axis length of the crystal lattice as calculated by the Rietveld method satisfy the relationship of formula (1), so that the barium titanate can have a small particle diameter and excellent electric properties with high dielectric constant. When a dielectric material such as dielectric ceramic obtained from this barium titanate is used, a small-sized electric part such as multilayer ceramic capacitor is obtained. Furthermore, when such an electronic part is used for an electronic device, miniaturization and lightweighting of the electronic device can be realized. Thus, the present invention greatly contributes to the miniaturization and lightweighting of portable devices including cellular phone.

1. A perovskite-type barium titanate comprising at least one element selected from the group consisting of Sn, Zr, Ca, Sr, Pb, La, Ce, Mg, Bi, Ni, Al, Si, Zn, B, Nb, W, Mn, Fe, Cu, Ho, Y and Dy, in an amount of 5 mol % or less (inclusive of 0 mol %) based on BaTiO₃, wherein the molar ratio of A atom to B atom in the perovskite structure represented by ABX₃ (A atom is surrounded with 12× atoms, and B atom is surrounded with 6× atoms) is from 1.001 to 1.025, and the specific surface area x (m²/g) and the ratio y of the c-axis length to the a-axis length of the crystal lattice as calculated by the Rietveld method satisfy the following formula:
y>1.0083−6.53×10⁻⁷×x³
(wherein y=c-axis length/a-axis length, and 6.6<x≦20).

2. The barium titanate according to claim 1, wherein the specific surface area x (m²/g) and the ratio y of the c-axis length to the a-axis length of the crystal lattice as calculated by the Rietveld method satisfy the following formula:
y>1.0083−6.53×10⁻⁷×x³
(wherein y=c-axis length/a-axis length, and 7<x≦20).

3. The barium titanate according to claim 1, which is in the form of powder.

4. A process for producing a barium titanate according to claim 1, comprising:
a step of reacting a titanium oxide sol and a barium compound in an alkaline solution having a carboxylic acid group concentration of 500 ppm by mass or less in terms of CO₂ and allowing for the presence of a basic compound, to synthesize a barium titanate;
a step of removing the basic compound in the form of a gas after the completion of reaction; and
a step of firing the barium titanate.

5. The process for producing a barium titanate according to claim 4, wherein the titanium oxide sol is produced by hydrolyzing a titanium compound under acidic conditions.

6. The process for producing a barium titanate according to claim 4, wherein the titanium oxide sol contains a brookite crystal.

7. The process for producing a barium titanate according to claim 4, wherein the basic compound is a substance which becomes a gas by any one or more means of evaporation, sublimation and thermal decomposition at a firing temperature or less under atmospheric pressure or reduced pressure.

8. The process for producing a barium titanate according to claim 7, wherein the basic compound is an organic base compound.

9. The process for producing a barium titanate according to claim 4, wherein the alkaline solution has a pH of 11 or more.

10. The process for producing a barium titanate according to claim 4, wherein the step of removing the basic compound in the form of a gas is performed at a temperature ranging from room temperature to a firing temperature under atmospheric pressure or reduced pressure.

11. The process for producing a barium titanate according to claim 4, wherein the step of removing the basic compound in the form of a gas is included in the firing step.

12. The process for producing a barium titanate according to claim 4, wherein the firing step is performed at 300 to 1,200° C.

13. The process for producing a barium titanate according to claim 4, wherein in the step of reacting a titanium oxide sol and a barium compound, a compound containing at least one element selected from the group consisting of Sn, Zr, Ca, Sr, Pb, La, Ce, Mg, Bi, Ni, Al, Si, Zn, B, Nb, W, Mn, Fe, Cu, Ho, Y and Dy is added.

14. A barium titanate produced by the process according to claim 4.

15. A dielectric material comprising the barium titanate according to claim 1.

16. A paste comprising the barium titanate according to claim 1.

17. A slurry comprising the barium titanate according to claim 1.

18. A thin-film shaped product comprising the barium titanate according to claim 1.

19. A dielectric ceramic produced by using the barium titanate according to claim 1.

20. A pyroelectric ceramic produced by using the barium titanate according to claim 1.

21. A piezoelectric ceramic produced by using the barium titanate according to claim 1.

22. A capacitor comprising the dielectric ceramic according to claim 19.

23. An electronic device comprising at least one member selected from the group consisting of the thin-film shaped product, the ceramic and the capacitor according to claim 18.

24. A sensor comprising one species or two or more species of the thin-film shaped product or ceramic according to claim 18.

25. A dielectric film comprising the barium titanate according to claim 1.

26. A capacitor produced by using the dielectric film according to claim 25.
